(19) United States
(12) Patent Application Publication
(10) Pub. No.: US 2005/0050706 A1
(43) Pub. Date: Mar. 10, 2005

(54) Method and apparatus for rivet removal

(76) Inventor: Douglas Motzno, Raleigh, NC (US)

Correspondence Address: Norman B. Rainer, 2008 Fondulac Road, Richmond, VA, 23229, US

(21) Appl. No.: 10/654,016

(22) Filed: Sep. 4, 2003

(51) Int. Cl. B24C 5/00; B23P 19/02

(52) U.S. Cl. 29/426.5; 29/426.4; 29/700

(57) ABSTRACT

A method and apparatus for the removal of rivets from steelwork employs a high velocity narrow stream of water, containing abrasive particles, to cut through the head of the rivet in a circular path that produces a ring. The remainder of the rivet is then easily extricated from the steelwork. The apparatus includes a cutting head assembly having a nozzle that is driven in a circular path. A mounting device removable anchored to the steelwork supports the cutting head assembly.

### BACKGROUND OF THE INVENTION

1. Field of the Invention

This invention relates to the removal of rivets from bridges or other structures by using apparatus having a cutting tool mounted so as to make the removal process efficient, safe, reliable and easy.

2. Description of the Prior Art

Rivets are not generally used in constructing modern bridges because it has been observed that over time, rivets lose strength and tension due to stress and vibration on the bridge structure, and undergo corrosive deterioration. However, rivets were widely used in the recent past to build bridges and other structures. Since these are enormously expensive structures to build, and since structural integrity is critical, it is common practice to remove rivets from older bridges and replace them with tension-controlled bolts or high strength fasteners that can be tensioned and maintained over time.

Rivets typically employed in securing abutting steel beams are fabricated of iron and comprised of a circular cylindrical shaft terminating in a first or manufactured head. The rivet is usually heated to a red heat in preparation for insertion through aligned holes in the beams. Following insertion, an opposite second head is produced by hammering.

Up until now, the removal of rivets from bridges or other structures has been accomplished using jackhammers, grinding tools, milling tools, drills, torches, and other implements. This is a difficult task, and tends to disturb the protective paint on and around the rivets. Said paint generally contains lead and/or chromate compounds intended to inhibit corrosion. If dispersed as particulate matter into the ambient air or water, such compounds present toxicity concerns.

Improper use of prior tools can introduce heat, which can damage surrounding metal. Such methods are physically demanding, dangerous, and time-consuming, often requiring from ten minutes to three hours to remove each rivet. A particularly challenging aspect of the rivet-removing operation is to accurately position and secure the usually heavy cutting tool upon the rivet, particularly on vertical side surfaces. Although the use of a high velocity jet of water containing suspended abrasive particles is known as a cutting modality, its application to the specific requirements of rivet removal has not heretofore been suggested.

It is accordingly an object of the present invention to provide a process for the rapid removal of rivets from structural steel forms.

It is another object of this invention to provide a process of the aforesaid nature which employs a high velocity jet of water which contains suspended abrasive particles.

It is a further object of the present invention to provide a process of the aforesaid nature which removes minimal amounts of metal and protective paint from the area contiguous to said rivet.

It is a still further object of this invention to provide a process of the aforesaid nature which minimizes the release of said paint in particulate form into the ambient environment.

It is yet another object of the present invention to provide apparatus for accomplishing the aforesaid process features.

It is an additional object of the present invention to provide apparatus of the aforesaid nature which accurately positions and secures a cutting tool upon a rivet.

These objects and other objects and advantages of the invention will be apparent from the following description.

### SUMMARY OF THE INVENTION

The process of the present invention comprises cutting through at least one head of a rivet in a circular path congruent with the cylindrical surface of the rivet shaft, thereby removing as a ring the portion of the outer extremity of the head that extends outwardly beyond the shaft, then pushing upon the remaining center portion of said head to dislodge the rivet, said cutting being accomplished by a high velocity narrow stream of water containing suspended abrasive particles.

The apparatus of the present invention is comprised of:
a) an ultra-high pressure pump capable of providing water pressurized to at least 35,000 PSI,
b) water filtration means for supplying filtered water to said pump,
c) means for entering particulate abrasive material into said pressurized water,
d) a cutting head assembly, including a nozzle which receives said abrasive-containing pressurized water and directs it as a narrow, high velocity stream capable of cutting through steel,
e) mounting means for supporting said cutting head and achieving accurate positioning thereof with respect to a rivet targeted for removal,
f) drive means associated with said cutting head assembly for causing said nozzle to move in a circular path congruent with the cylindrical surface of the rivet shaft, and
g) collection means disposed in spaced apart relationship with said nozzle for receiving debris produced by the interaction of said high velocity stream with said rivet.

### BRIEF DESCRIPTION OF THE DRAWING

For a fuller understanding of the nature and objects of the invention, reference should be had to the following detailed description taken in connection with the accompanying drawing forming a part of this specification and in which similar numerals of reference indicate corresponding parts in all the figures of the drawing:

FIG. 1 is a perspective schematic view showing a conventional rivet which secures abutting steel beams, and a cutting tool performing the removal process of this invention.

FIG. 2 is a side view of the embodiment of FIG. 1.

FIG. 3 is a schematic side view of a cutting head assembly useful in the embodiment of FIG. 1, with portions broken away to reveal interior details.

FIG. 4 is a perspective side view of a first embodiment of mounting means useful in the apparatus of the present invention, shown in operative association with the cutting head assembly of FIG. 3.

FIG. 5 illustrates a second embodiment of mounting means useful in the apparatus of this invention.

FIG. 6 is a perspective view of a third embodiment of mounting means useful in the apparatus of the present invention.

FIG. 7 is a schematic view of a truck-mounted embodiment of the apparatus of this invention.

### DESCRIPTION OF THE PREFERRED EMBODIMENTS

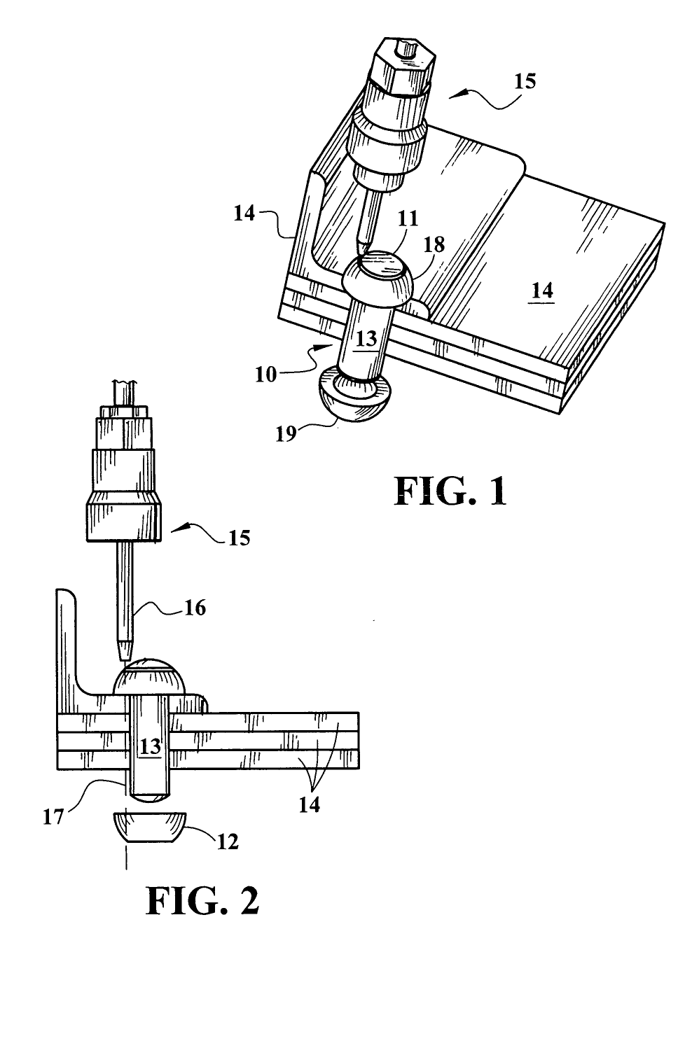

Referring to FIGS. 1 and 2, a rivet 10 of conventional configuration is shown comprised of first head 11, second head 12, and intervening circular cylindrical shaft 13. The rivet, serving to secure together abutting flat structural steel members 14, is shown as it would appear following the cutting process of this invention.

A cutting head assembly 15 operatively secures nozzle 16 and causes it to travel in a circular path above first head 11 while emitting a high velocity narrowly collimated stream 17 of water containing suspended abrasive particles, said stream having the ability to cut through steel. Said circular path is congruent with the cylindrical surface of shaft 13, thereby removing as a ring 18 the portion of the outer extremity of head 11 that extends outwardly beyond the shaft. In the illustrated, preferred embodiment, stream 17 is caused to continue upon a path tangent to shaft 13 and emerge through second head 12, thereby producing second ring 19. Once the aforesaid cutting of at least first head 11 has been achieved, the remainder of the rivet may be pushed away from engagement with said steel members. The removal of the rivet has been found easier when the cutting stream penetratively acts upon both heads. This is presumably because any corrosive bonding between the shaft of the rivet and the steel members is removed. The removed rivet is quickly replaced with a new fastening device.

The stream is preferably of circular configuration, having a diameter such as to produce a kerf width (cutting path) between about 0.03 and 0.04 inch. The stream has a linear velocity of between mach 1 (1090 feet/second) and mach 2, and is caused to complete its circular path within 1 to 15 minutes, representing a travel rate between 2.75 and 0.183 inches/minute, depending upon the depth of cut and diameter of rivet shaft. The stream contains between 10 and 15 weight percent of abrasive particles, said particles having a size between 16 and 500 microns. Suitable abrasive particles include corundum, silicon carbide, garnet, silica, aluminum oxide, copper slag and particulate carbon dioxide. The distal tip 66 of nozzle 16 is positioned between 1 and 2 mm. from the first head 11 of the rivet.

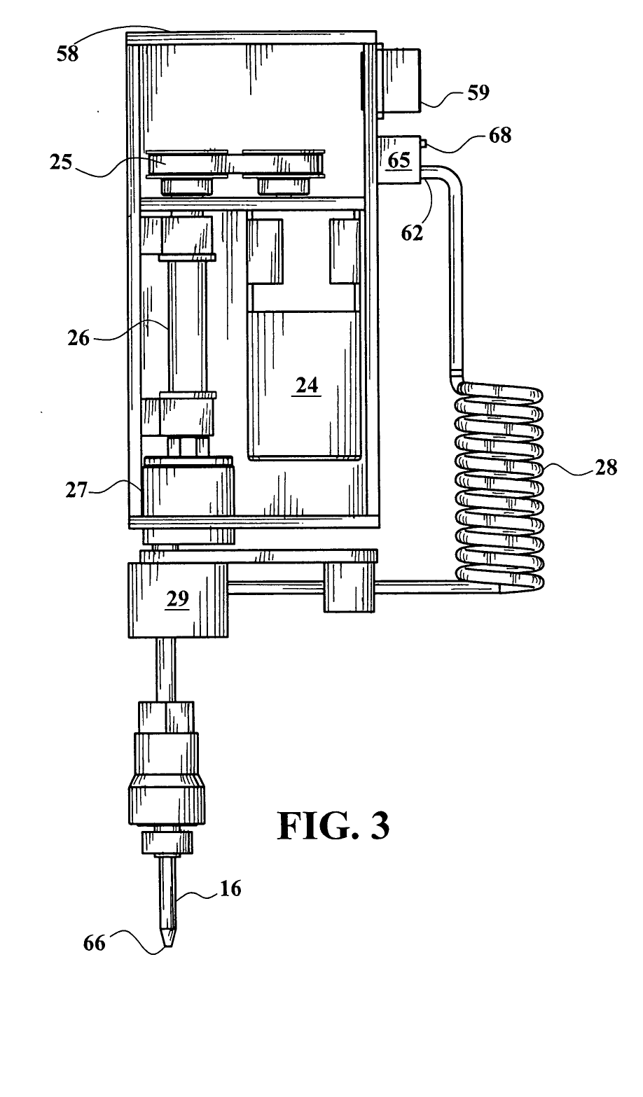

Cutting head assembly 15, as best shown in FIG. 3, is further comprised of drive motor 24 interactive with drive pulley system 25 and drive shaft 26 terminating in offset adjustment means 27 which sets the diameter of the circular path of nozzle 16. Said components of cutting head assembly are enclosed within a box-like housing 58 having external electrical connector terminal 59. A coiled conduit 28 conveys a pressurized flow of abrasive-containing water to delivery head 29 which feeds nozzle 16. The coiled configuration of conduit 28 accommodates the movement of delivery head 29 and nozzle 16 in the course of their circular path. The upper, inlet extremity 62 of conduit 28 preferably joins with an electrically controlled valve 65 which may be positioned atop housing 58. A quick-release fluid coupling 68 may be associated with valve 65 to expedite releasable joinder with an upstream conduit that conveys the cutting fluid to said valve.

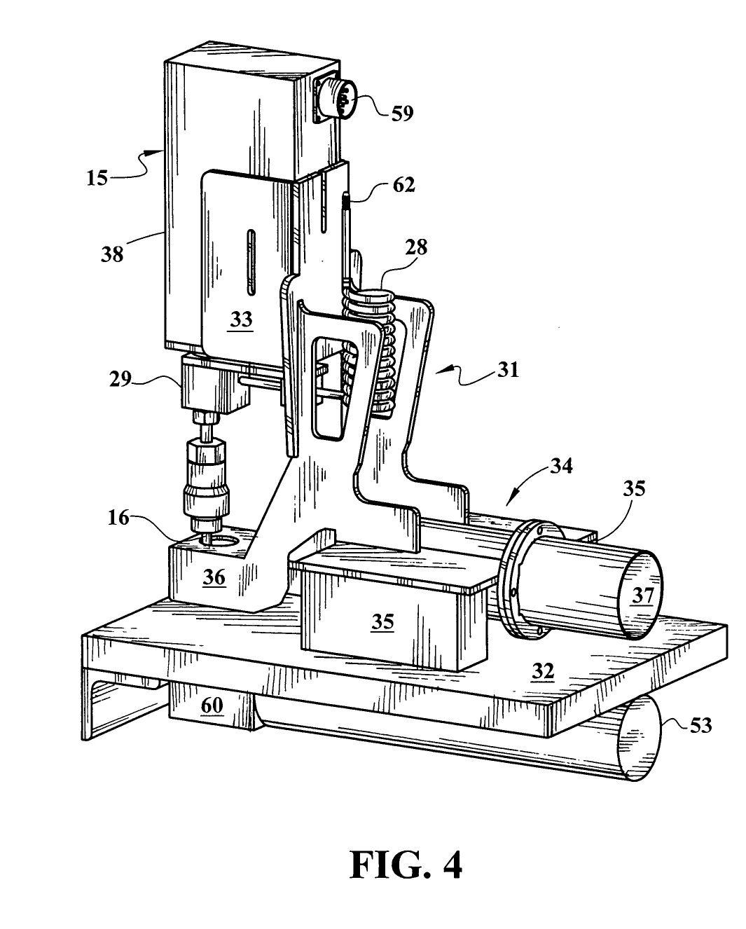

The cutting head assembly 15 is accurately secured in proper position with respect to the rivet workpiece by adjustable mounting means 31. A first embodiment of such mounting means, suitably used when a horizontally extending ledge component 32 of the steelwork structure can be employed for support, is shown in FIG. 4. Said embodiment comprises a receiving bracket 33 which adjustably engages cutting head assembly 15, and base assembly 34 having anchoring means in the form of bi-polar electromagnets 35 controllably interactive with ledge 32. A catching enclosure 36, extending forwardly from base assembly 34 embraces nozzle 16 and the underlying rivet workpiece for the purpose of confining debris produced by the cutting operation. A vacuum port 37, extending rearwardly from said base assembly, communicates with catching enclosure 36 for the purpose of removing said debris. Auxiliary catching enclosure 60 and interactive vacuum removal means 53 may be positioned beneath ledge 32 for receiving debris emergent from the second head of the rivet.

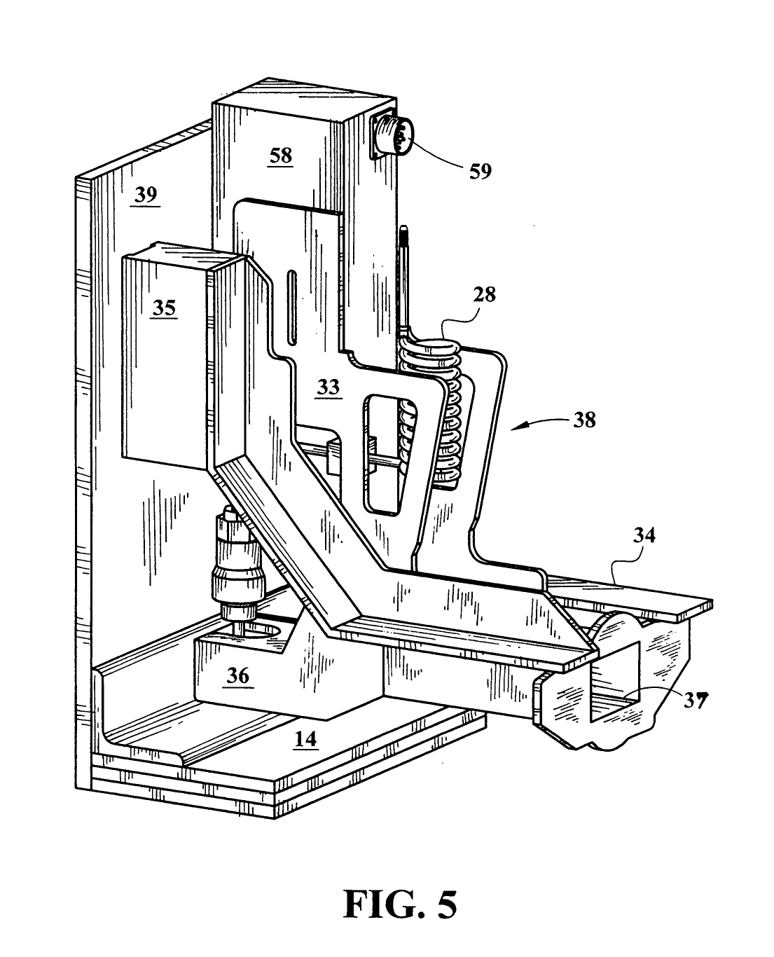

FIG. 5 illustrates a second embodiment of said mounting means, designated by numeral 38, and intended for controlled attachment to a vertical steel member 39 adjacent the rivet workpiece. The components of mounting means 38 are generally the same as those for mounting means 31. However, catching enclosure 36 and vacuum port 37 are re-arranged to be located downwardly from base assembly 34.

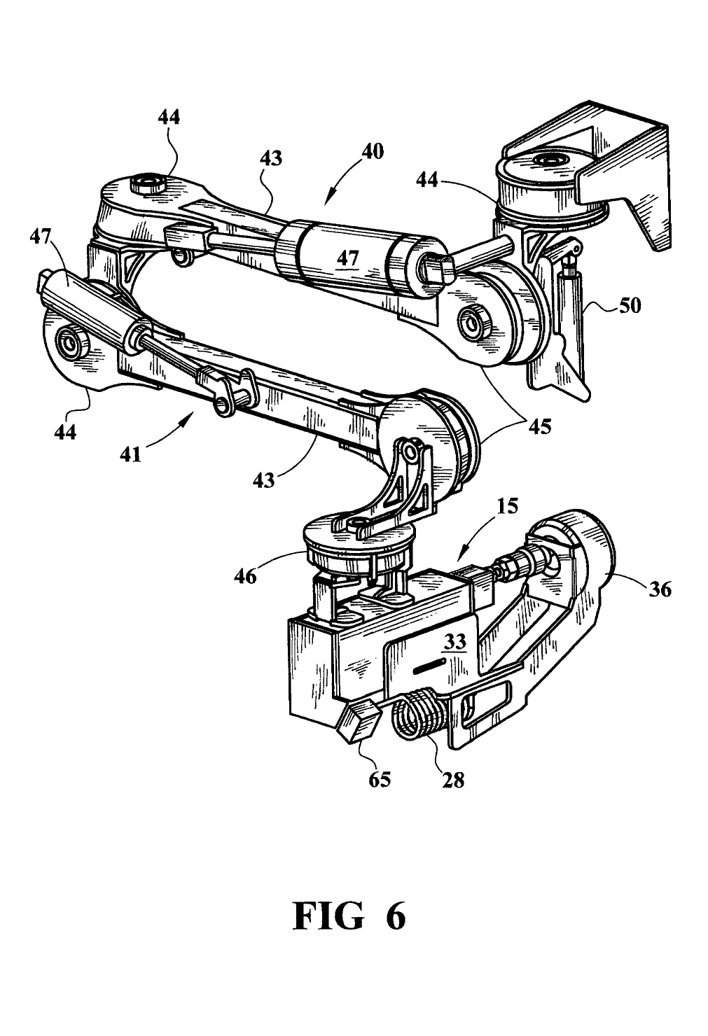

A third embodiment of said mounting means, designated by numeral 40, and including an articulated arm 41, is illustrated in FIG. 6. Said mounting means 40 includes a base assembly 42, which may be equipped with anchoring means in the form of electromagnets or clamping devices for controlled attachment to a suitable steel surface adjacent the rivet workpiece. Arm components 43 of adjustable length terminate in bearing-equipped pivot hubs 44. Distal hub 45 supports a positioning hub 46 mounted for rotational movement in a plane orthogonal to the plane of rotation of said distal hub. Positioning hub 46 is attached to a cutting head assembly 15 secured within the receiving bracket 33 of mounting means 31. Support means, in the form of air cylinders 47 support the combined weight of the arms, associated components, mounting means 31, and cutting head assembly 15. By virtue of the adjustable support provided by the air cylinders 47, and other features of construction, the cutting head assembly has freedom of movement over a wide range of motion, and is caused to be weightless to the operator, thereby facilitating easy manipulation. In alternative embodiments, the supporting air cylinders may be replaced by springs or hydraulic cylinders. Braking means, in the form of drum or disc brakes operated by air cylinders 50 are interactive with each pivot hub. Activation of said braking means locks the entire assembly into a particular configuration which accurately positions nozzle 16. Articulated arm assemblies similar to that shown in FIG. 6 are available from the Midwest Speciality Company of Wapakoneta, Ohio.

A pump suitable for pressurizing water to 35,000 to 55,000 psi is Jet Edge model 55-260DXUHP mobile pump powered by a diesel engine made by the Jet Edge Company of St. Michael, Minn. Other suitable pumps may be powered by diesel, gasoline or natural gas engines.

The cutting operation may be manually controlled, or may be computer-aided in its operation, including start/stop, depth of cuts and positioning during local and remote operation. The cutting head may be positioned over the rivet manually using mechanical indicators, optical devices involving triangulating lasers, or other alignment means.

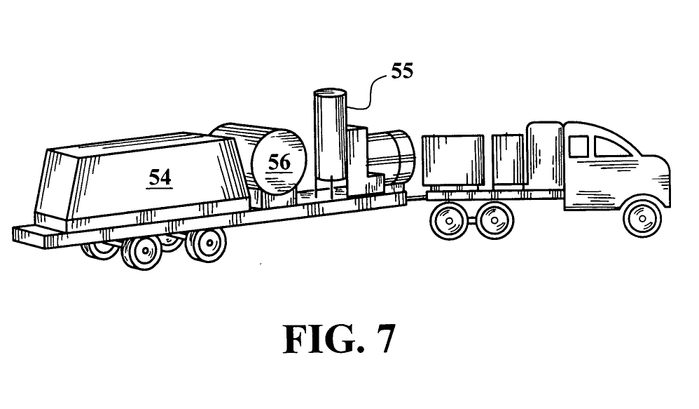

The various operating components of the apparatus of the present invention are preferably assembled upon a portable vehicle such as a truck, as shown schematically in FIG. 7. Other vehicles include barges and railway units. The truck-mounted assembly of FIG. 7 includes a pump unit 54, abrasive supply vessel 55 and industrial vacuum unit 56. Various appropriate electrical and fluid connecting means are associated with the several truck-mounted components.

When in use, the operator will adjust offset adjustment means 27 to the sought diameter of travel of the nozzle. Then, the operator releases the braking means and positions the cutting head. The brake system is re-engaged. The auxiliary catching/vacuuming means is positioned on the opposite head of the rivet and locked in place by magnetic or mechanical means, and a start button is pushed. The system will automatically cycle to turn on the abrasive and water delivery systems, and will shut the system off at completion of the cut.

While particular examples of the present invention have been shown and described, it is apparent that changes and modifications may be made therein without departing from the invention in its broadest aspects. The aim of the appended claims, therefore, is to cover all such changes and modifications as fall within the true spirit and scope of the invention.

1) A method for removing from steelwork iron rivets having a circular cylindrical shaft terminating in a first, manufactured head and an opposite second head, said method comprising cutting through at least one head of said rivet in a circular path congruent with the cylindrical surface of said rivet shaft, thereby removing as a ring the portion of the outer extremity of the head that extends outwardly beyond the shaft, then pushing upon the remaining center portion of said head to dislodge the rivet, said cutting being accomplished by a high velocity narrow stream of water containing suspended abrasive particles.

2) The method of claim 1 wherein the cutting action of said stream is caused to continue past said head in tangential contact with said shaft and emerge through said opposite head, thereby producing a second ring.

3) Apparatus for removing an iron rivet from engagement with steelwork comprising:
a) an ultra-high pressure pump capable of providing water pressurized to at least 35,000 PSI,
b) water filtration means for supplying filtered water to said pump,
c) means for entering particulate abrasive material into said water,
d) a cutting head assembly, including a nozzle, which receives said abrasive-containing pressurized water and directs it as a narrow, high velocity stream capable of cutting through steel,
e) mounting means for supporting said cutting head and achieving accurate positioning thereof with respect to a rivet targeted for removal,
f) drive means associated with said cutting head assembly for causing said nozzle to move in a circular path congruent with the cylindrical surface of the rivet shaft, and
g) collection means disposed in spaced apart relationship with said nozzle for receiving debris produced by the interaction of said high velocity stream with said rivet.

4) The apparatus of claim 3 further provided with vacuum means interactive with said collection means to remove said debris.

5) The method of claim 1 wherein said high velocity narrow stream has a diameter such as to produce a kerf width between 0.03 and 0.04 inch.

6) The method of claim 5 wherein said high velocity narrow stream has a linear velocity of between mach 1 and mach 2.

7) The method of claim 6 wherein said high velocity narrow stream is caused to complete said circular path within 1 to 15 minutes.

8) The method of claim 5 wherein said high velocity narrow stream contains between 10 and 15 weight percent of abrasive particles.

9) The method of claim 8 wherein said abrasive particles have a size between 16 and 500 microns.

10) The method of claim 5 wherein said high velocity narrow stream is emergent from a nozzle positioned between 1 and 2 mm. from the first head of said rivet.

11) The apparatus of claim 4 further provided with means for adjusting the diameter of the circular path of said nozzle.

12) The apparatus of claim 11 further provided with a coiled conduit that supplies said abrasive-containing pressurized water to said nozzle.

13) The apparatus of claim 3 wherein said mounting means has a base which includes anchoring means for releasibly securing said mounting means to said steelwork.

14) The apparatus of claim 13 wherein said anchoring means comprises electromagnets.

15) The apparatus of claim 3 wherein said mounting means includes an articulated arm having pivot hubs and interactive stabilizing brakes.

16) The apparatus of claim 3 further comprising means for automatically stopping the flow of pressurized water to said nozzle when said nozzle has completed its circuitous cutting path.
